(19) United States
(12) Patent Application Publication
(10) Pub. No.: US 2026/0351272 A1
(43) Pub. Date: Nov. 5, 2026

(54) Binaural Audio Enhancement Systems and Methods for Wearable Audio Devices

(71) Applicant: Google LLC, Mountain View, CA (US)

(72) Inventors: Jean-Marc Valin, Montréal (CA); Tanvir Mahmud, Sunnyvale, CA (US); Maxwell James Christian Gailey, San Francisco, CA (US); Arvindh Krishnaswamy, Palo Alto, CA (US)

(21) Appl. No.: 19/664,846

(22) Filed: Apr. 30, 2026

Related U.S. Application Data
(60) Provisional application No. 63/797,770, filed on Apr. 30, 2025.

(51) Int. Cl. G10L 21/0232; G10L 15/06; G10L 15/16; G10L 15/183; G10L 21/034; G10L 21/0364; G10L 25/18; G10L 25/24; G10L 21/0216

(52) U.S. Cl. CPC G10L 21/0232; G10L 15/063; G10L 15/16; G10L 15/183; G10L 21/034; G10L 21/0364; G10L 25/18; G10L 25/24; G10L 2021/02166

(57) ABSTRACT

An audio enhancement system enhances audio signals such as speech from microphones in a fixed spatial configuration, such as in earbuds. A binaural speech enhancement model processes audio signals from both microphones using delay-and-sum beamforming and difference signal processing. The model generates a mid signal from an average of first and second audio signals and a side signal from the difference between them. An enhancement mask predictor generates a noise mask based on the mid and side signals, and then generates an enhanced signal. The system can use an automatic speech recognition model to generate an enhanced speech signal. The system can provide noise reduction for improving speech recognition accuracy in noisy environments using wearable devices such as earbuds.

### RELATED APPLICATIONS

This application claims priority to and the benefit of United States Provisional Patent Application Number 63/797,770, filed Apr. 30, 2025. United States Provisional Patent Application Number 63/797,770 is hereby incorporated by reference in its entirety.

### FIELD

The present disclosure relates generally to audio devices and audio enhancement for automatic speech recognition. More particularly, the present disclosure relates to binaural audio enhancement using machine-learned systems for wearable audio devices.

### BACKGROUND

Automatic Speech Recognition (ASR) technology has become increasingly prevalent across various applications, including mobile communication, voice search, and virtual assistants. However, a persistent challenge for ASR systems lies in maintaining high accuracy in the presence of background noise and acoustic interference. Traditional ASR systems often rely on single-channel audio input, which is inherently limited in its ability to distinguish target speech from surrounding noise sources. Leveraging multi-channel audio has the potential to enhance noise suppression and improve recognition accuracy. Nevertheless, existing multi-channel techniques often depend on specific microphone array configurations, which are impractical for wearable devices like earbuds due to their fixed microphone placements.

### SUMMARY

Aspects and advantages of embodiments of the present disclosure will be set forth in part in the following description, or can be learned from the description, or can be learned through practice of the embodiments.

One example aspect of the present disclosure is directed to an audio enhancement system that includes a first microphone and a second microphone having a fixed spatial configuration, one or more processors, and a memory including instructions that when executed by the one or more processors cause the audio enhancement system to perform operations. The operations include generating a mid signal and a side signal by delay-and-sum and difference signal processing of a first audio signal from the first microphone and a second audio signal form the second microphone, processing one or more features extracted from the mid signal and side signal with a mask prediction neural network to generate a gain mask, applying the gain mask to a magnitude spectrogram of the mid signal to generate an enhanced audio output, and processing the enhanced audio output with an automatic speech recognition model to generate a speech recognition output.

Another example aspect of the present disclosure is directed to a method for audio enhancement that includes receiving, by one or more computing devices, a first audio signal from a first microphone and a second audio signal from a second microphone. The first microphone and the second microphone have a fixed spatial configuration. The method includes generating a mid signal and a side signal by delay-and-sum and difference signal processing of the first audio signal and the second audio signal, processing one or more features extracted from the mid signal and the side signal with a mask prediction neural network to generate a gain mask, applying the gain mask to a magnitude spectrogram of the mid signal to generate an enhanced audio output, and processing the enhanced audio output with an automatic speech recognition model to generate a speech recognition output.

Yet another example aspect of the present disclosure is directed to a computer-implemented method that includes accessing training data comprising a noisy binaural speech signal and a corresponding clean reference audio signal, generating a mid signal and a side signal from the noisy binaural speech signal, extracting one or more spectral features from the mid signal and the side signal, processing the extracted one or more spectral features with a mask prediction neural network to generate a predicted gain mask, applying the predicted gain mask to the mid signal to generate an enhanced audio signal, processing the enhanced audio signal and the clean reference audio signal through an independent automatic speech recognition (ASR) model, wherein internal parameters of the independent ASR model are maintained in a frozen state such that the internal parameters of the independent ASR model are not updated during training of the mask prediction neural network, calculating a multi-part loss function based on processing the enhanced audio signal and the clean reference audio signal through the independent ASR model, and updating one or more internal parameters of the mask prediction neural network based on the calculated multi-part loss function.

Other example aspects of the present disclosure are directed to other systems, methods, apparatuses, tangible non-transitory computer-readable media, and devices for performing functions described herein. These and other features, aspects, and advantages of various implementations will become better understood with reference to the following description and appended claims. The accompanying drawings, which are incorporated in and constitute a part of this specification, illustrate implementations of the present disclosure and, together with the description, help explain the related principles.

### BRIEF DESCRIPTION OF THE DRAWINGS

Detailed discussion of embodiments directed to one of ordinary skill in the art is set forth in the specification, which makes reference to the appended figures, in which:

FIG. 1 is a block diagram depicting an example audio enhancement system in accordance with example embodiments of the present disclosure;

FIG. 2 is a block diagram illustrating an example audio enhancement architecture in accordance with example embodiments of the present disclosure;

FIG. 3 is a block diagram depicting a data pipeline in accordance with example embodiments of the present disclosure;

FIG. 4 is a flowchart depicting an example method of audio processing audio signals from multiple microphones to generate a speech recognition output in accordance with example aspects of the present disclosure.

FIG. 5 is a flowchart depicting an example method of training a mask prediction neural network in accordance with example aspects of the present disclosure.

FIG. 6 is a block diagram depicting a wearable audio device in accordance with example embodiments of the present disclosure;

FIG. 7 is a block diagram of an example computational system that can implement various systems and methods in accordance with example embodiments of the present disclosure;

FIG. 8 is a block diagram of an example computing system that performs audio enhancement according to example embodiments of the present disclosure;

FIG. 9 is a block diagram of an example computing device that performs audio enhancement according to example embodiments of the present disclosure; and

FIG. 10 depicts a block diagram of an example computing device that performs audio enhancement according to example embodiments of the present disclosure.

Reference numerals that are repeated across plural figures are intended to identify the same features in various implementations.

### DETAILED DESCRIPTION

Reference now will be made in detail to embodiments, one or more examples of which are illustrated in the drawings. Each example is provided by way of explanation of the embodiments, not limitation of the present disclosure. In fact, it will be apparent to those skilled in the art that various modifications and variations can be made to the embodiments without departing from the scope or spirit of the present disclosure. For instance, features illustrated or described as part of one embodiment can be used with another embodiment to yield a still further embodiment. Thus, it is intended that aspects of the present disclosure cover such modifications and variations.

Generally, the present disclosure is directed to a low-complexity real-time binaural audio enhancement system such as can be implemented for automatic speech recognition or other enhancement systems for wearable audio components such as in-ear acoustic devices (e.g., earbuds) or other wearable audio devices. In accordance with example embodiments of the present disclosure, a lightweight binaural audio enhancement framework is provided that uses beamforming and difference signal processing to exploit spatial information from dual microphones or other audio sources. In example embodiments, the framework can include a binaural speech enhancement model that is configured to generate from a first audio signal from a first microphone (e.g., a left microphone) and a second audio signal from a second microphone (e.g., a right microphone) an enhanced audio signal based on delay-and-sum beamforming and difference signal processing. The framework can integrate an automatic speech recognition (ASR) model to improve speech recognition accuracy in the presence of noise. The framework can integrate the ASR model in the training loop, significantly improving audio enhancement performance over traditional enhancement loss functions. The enhancement model can be optimized for real-time operation with limited computational resources.

Traditional ASR systems employ approaches such as noise reduction algorithms to preprocess the audio signal before feeding it to the ASR engine. These algorithms typically operate by estimating the noise characteristics and suppressing them from the input signal. While such single-channel noise reduction methods can improve ASR accuracy to some extent, their effectiveness is often limited, particularly in complex acoustic environments with non-stationary noise sources or interfering speakers.

Multi-microphone techniques offer a promising alternative for enhancing ASR robustness. By utilizing multiple microphones, the spatial diversity can be exploited to separate target speech from noise. Beamforming, a classical multi-microphone technique, combines signals from multiple microphones to enhance the signal from a specific direction while attenuating signals from other directions. While beamforming can be effective in certain scenarios, its performance is highly dependent on the accuracy of the estimated direction-of-arrival (DOA) of the target speech. In practical applications, accurately estimating the DOA can be challenging, especially in reverberant environments or when the target speaker is moving.

More advanced multi-channel signal processing techniques, such as independent component analysis (ICA) and blind source separation (BSS), have also been applied to ASR. These techniques aim to separate the mixed audio signals into individual source components without requiring prior knowledge of the source locations or characteristics. However, ICA and BSS algorithms often involve high computational complexity, which can be a significant limitation for real-time applications, particularly on resource-constrained devices.

Earbuds with integrated microphones present a unique set of challenges and opportunities for ASR enhancement. The close proximity of the microphones to the user's mouth offers the potential for capturing high-quality speech signals. However, the fixed placement of the microphones also limits the flexibility of traditional beamforming techniques that rely on adjustable microphone arrays. Furthermore, earbuds are often used in noisy and complex acoustic environments, such as crowded streets or public transportation, where robust noise reduction enables accurate ASR performance. Existing solutions often fail to fully address these challenges, resulting in suboptimal ASR accuracy in real-world earbud applications. The limitations of these prior art approaches highlight the need for a more effective and efficient binaural audio enhancement system tailored for earbud-based ASR.

According to an example implementation, an audio enhancement system is provided that can be implemented for a wearable audio component such as a pair of earbuds. The audio enhancement system can include a binaural audio enhancement model that can leverage the fixed spatial configuration of dual microphones or other audio sources to extract inherent spatial cues for effective noise suppression. The system can integrate delay-and-sum beamforming and difference signal processing with a lightweight binaural enhancement model.

The system can include an enhancement mask predictor configured to predict a noise mask based on a mid signal and a side signal generated by a beamformer. The mid signal and the side signal can be derived from a first audio signal from a first microphone (e.g., a left microphone) and a second audio signal from a second microphone (e.g., a right microphone). The beamformer can include a mean signal extractor configured to combine the first audio signal and the second audio signal to generate the mid signal based on an average of the first audio signal and the second audio signal. The beamformer can also include a difference signal processor configured to generate the side signal based on a difference between the first audio signal and the second audio signal. The side signal contains information about inter-channel coherence between the first audio signal and the second audio signal.

The binaural speech enhancement model can be configured to generate an enhanced signal based on the noise mask and the mid signal. The system can also include a speech reconstructor configured to apply the noise mask to a magnitude spectrogram of the mid signal to generate a single enhanced mono-channel signal. The system can include an ASR model configured to generate an enhanced speech signal based on the enhanced audio signal from the speech reconstructor. The ASR model can include a neural network based on gated recurrent units. The speech enhancement system can be trained using a plurality of losses including a mask loss, an automatic speech recognition encoder output pass, and an automatic speech recognition language model loss.

The audio enhancement system can include a beamformer configured to generate, from the first audio signal and the second audio signal, a mid signal and a side signal. The beamformer can include a mean signal extractor configured to combine the first audio signal and the second audio signal to generate the mid signal based on an average of the first audio signal and the second audio signal. A delay-and-sum beamformer can sum the audio signals after delay-compensation for the direction of arrival such that the channel components from the direction of interest add constructively while those from other directions cancel out. Since a wearer's mouth is equidistance from each of a pair of earbuds, compensation for delay can be omitted such that beamforming reduces to averaging the left and right channels. The beamformer can also include a difference signal processor configured to generate the side signal based on a difference between the first audio signal and the second audio signal. Whereas summing the channels enhances the target speech, computing the difference between channels emphasizes the noise components while attenuating the speech. The side signal contains noise and interference information from non-target sources, providing the model with cues about background noise characteristics in the environment. The side signal contains information about inter-channel coherence between the first audio signal and the second audio signal where the delay is zero.

The binaural audio enhancement model can use both the mid signal and the side signal to generate an enhanced signal for target speech enhancement. The enhancement model can use both the mid signal and the side signal to compute a signal mask for the beamformed signal. In an example implementation, frequency cepstral coefficients (FCCs) can be computed and used as input features to a model that estimates the real-valued ideal gain mask to determine the enhanced signal. The binaural audio enhancement model can include a reconstructor to reconstruct audio by applying the estimated mask to the magnitude spectrogram of the beamformed signal. The reconstructor can yield a single enhanced mono-channel signal. The enhanced audio signal can be provided to an ASR model. The ASR model can include a neural network based on gated recurrent units, enabling real-time processing.

The binaural model can be trained to ensure scalability across automatic speech recognition architectures. For example, the ASR model can be kept frozen during training to train the enhancement model. The training process can include multiple types of supervision. For example, a mask loss can be defined between the predicted gain and the ideal ratio mask of the clean and noisy signals. The training can also include an Automatic Speech Recognition (ASR) encoder loss based on the ASR encoding of the enhanced and reference (clean) speech signals. The training can also include an ASR language model loss. The ASR language model loss can be calculated using the ground-truth transcriptions to encourage the enhanced audio to align with the clean speech representations in the ASR model. The combined loss can ensure that the model focuses on optimizing for ASR performance rather than generic speech enhancement, enabling real-time adaptability for ASR applications in noisy environments.

Training the binaural enhancement model can include using training data generated through a data collection and modeling pipeline for simulating realistic acoustic conditions for binaural ASR enhancement. An ASR corpus can be used for clean mono-channel speech. Enhanced versions can be used to ensure high-quality audio. Binaural speech can be generated by applying Head-Related Transfer Functions (HRTFs) collected from earbuds. Self-voice HRTFs can be collected using a dummy head setup, with sine-sweeps played from a mouth position and recorded through earbuds to capture spatial characteristics. Additional recordings from users can be collected but in an example implementation only dummy head HRTFs can be used for experiments to ensure synchronization. Separate HRTFs can be designated for training and testing to maintain data integrity. Directional HRTFs for interfering speech can be obtained by playing sine-sweeps from various angles relative to the user.

The responses recorded from earbuds can enable spatial modeling of directional interference. Separate HRTFs can be used for training and testing. Real-world binaural noise can be recorded in diverse environments such as cafes, parks, and buses using an ambisonic speaker setup. Pre-recorded ambisonic noises can be played and recorded directly from earbuds. Clean binaural speech can be generated using self-voice HRTFs, while directional interfering speech and real-world noise can be mixed to model realistic scenarios. Combined datasets can be created to simulate complex conditions, integrating both interference and environmental noise for robust evaluation.

In example implementation, an initial processing operation can involve generating a mid signal and a side signal from the raw audio captured by the microphones. A first audio signal can be received from the first microphone, and a second audio signal can be received from the second microphone. These two signals can be processed to create the mid and side signals using techniques related to delay-and-sum beamforming and difference signal processing. The mid signal, in some embodiments, can be a beamformed average signal. In the context of earbuds worn by a user, the user's mouth is typically located at a position roughly equidistant from the left and right ears. Consequently, the travel time of the user's speech to each microphone is approximately equal. This can facilitate a simplification of a delay-and-sum beamforming algorithm, wherein a delay compensation step may be omitted. Thus, the mid signal can be generated by averaging the first audio signal and the second audio signal. This averaging process can cause correlated speech components arriving from the centered direction of the user's mouth to add constructively, thereby enhancing the target speech relative to uncorrelated or off-center noise sources.

Concurrently, a side signal can be generated. The side signal, also referred to as a difference signal, can be generated by subtracting the second audio signal from the first audio signal, or vice-versa. This operation can have an effect opposite to that of the averaging process used for the mid signal. The highly correlated, centered speech components can be attenuated or cancelled, while less correlated and unaligned sounds from the surrounding environment can be emphasized. These unaligned sounds can include diffuse background noise, directional interfering speakers, and reverberant energy. The resulting side signal can therefore provide a reference or cue for the characteristics of the ambient noise field. It can provide the system with information about the noise to be suppressed from the target speech.

Following the generation of the time-domain mid and side signals, the system can extract one or more features from both signals to prepare them for processing by a neural network. This can involve transforming the signals into a time-frequency domain representation using, for example, a Short-Time Fourier Transform (STFT). The STFT operation can utilize a window function, such as a suitable analysis window function, which may be selected to facilitate reconstruction of the audio signal at a later stage. From the resulting complex-valued spectrograms of the mid and side signals, a first set of spectral features can be extracted from the mid signal, and a second set of spectral features can be extracted from the side signal. In some embodiments, these features can be Mel-frequency cepstral coefficients (MFCCs). MFCCs can provide a representation of the short-term power spectrum of a sound, designed to approximate the non-linear frequency response of the human ear, and are used in some speech processing applications. In other embodiments, the features could be log-Mel spectrograms or other suitable spectral representations.

These extracted features—both the set from the mid signal (representing noisy speech) and the set from the side signal (representing a noise profile)—can then be processed by a mask prediction neural network. This network can generate a gain mask, which can be a time-frequency matrix that, when applied to the noisy speech signal, suppresses noise while preserving the speech. The neural network can be configured to be lightweight and computationally efficient, making it suitable for real-time operation on resource-constrained hardware, such as the processors within wearable devices (e.g., smart watches, earbuds, augmented reality glasses, etc.). In one example embodiment, the mask prediction neural network comprises a binaural enhancement model that includes one or more sequential one-dimensional convolutional (Conv1D) layers followed by one or more Gated Recurrent Unit (GRU) layers. The Conv1D layers can process the input features to identify local patterns across frequency or time, while the GRU layers are a form of recurrent neural network that can model temporal dependencies in the audio sequence, allowing the model to process information related to the dynamic evolution of both speech and noise over time.

The output of the mask prediction neural network can be the gain mask. In some embodiments, the network is configured to estimate the mask based on a Mel band structure, meaning it can predict a single gain value for each of a plurality of Mel-frequency bands rather than for every individual frequency bin of the STFT. This can further reduce computational complexity. The gain mask itself can take several forms. For example, it can be a real-valued Ideal Ratio Mask (IRM). An IRM can be a mask where each element represents the ratio of the target speech energy to the total mixture energy (speech plus noise) in a given time-frequency bin. A value of approximately 1 may indicate the bin contains predominantly speech, while a value of approximately 0 may indicate it contains predominantly noise. The neural network can be trained to predict an approximation of such a mask based on its inputs.

Once the gain mask is generated, the system can apply it to a magnitude spectrogram of the mid signal to produce an enhanced audio output. This application can be performed via an element-wise or band-wise multiplication of the gain mask with the magnitude values of the mid signal's spectrogram. This operation can selectively reduce the energy in time-frequency regions identified by the mask as being dominated by noise. The result of this step can be a masked magnitude component, which represents an enhanced magnitude spectrogram. To reconstruct an audio signal, this enhanced magnitude can be combined with a phase component. In many embodiments, the system can generate a single enhanced mono-channel audio signal by combining the masked magnitude component with a preserved phase component from the original, noisy mid signal. Reusing the noisy phase can be a computationally efficient strategy that can produce suitable results for ASR purposes. The combination of the enhanced magnitude and the preserved phase can create a new complex-valued spectrogram, which is then converted back into a time-domain waveform using an inverse STFT.

The reconstructed and enhanced audio output, in the form of a single enhanced mono-channel audio signal, can be processed by a downstream automatic speech recognition (ASR) model. This ASR model can take the enhanced audio signal as its input and perform speech-to-text conversion, generating a speech recognition output, such as a text transcription. An objective of the enhancement pipeline can be to improve the accuracy of this output, as may be measured by metrics like Word Error Rate (WER).

The mask prediction neural network can be trained using a transcription-driven training process. The internal parameters of the network can be configured via this process, which can utilize a multi-part loss function to train the network for the downstream ASR task. The training can be performed using an independent, frozen ASR model. The ASR model may be referred to as "frozen" in that its internal weights and parameters can be locked and are not updated during the training of the enhancement network. The frozen ASR model can be used to generate one or more loss components for training the enhancement network.

The multi-part loss function can include several components. In some embodiments, it can include a mask loss. This can be, for example, an L2 loss (mean squared error) calculated between the generated gain mask and a ground-truth ideal ratio mask associated with a known clean reference audio signal from a training dataset. This can provide supervision to the network, encouraging it to learn a mapping from noisy inputs to a target mask. The loss function can also include at least an encoder loss and a language model loss, both derived from the frozen ASR model. The ASR encoder loss can be calculated by passing both the enhanced audio and the clean reference audio through an encoder of the frozen ASR model and computing a loss (e.g., L1 or L2 distance) between their respective internal representations. This can train the enhancement network to generate audio that is structurally similar to clean audio from the ASR model's perspective. The ASR language model loss can be a transcription-level loss. It can be calculated based on the difference between the ASR model's text output for the enhanced audio and the ground-truth text transcription. By including this loss, the training process can train the enhancement network to produce audio that may be more accurately transcribed by the ASR model. This transcription-driven training can configure the gain mask generation for a machine transcription feature space, as opposed to training for metrics related to human acoustic fidelity or perceptual listening quality.

An example technical problem solved by example implementations of aspects of the present disclosure may include the challenge of performing real-time speech enhancement on computationally constrained wearable devices (e.g., earbuds, smart watches, etc.). Some multi-channel noise suppression algorithms can be computationally demanding in terms of processing power and memory, which may make them less suitable for the hardware resources of some small, battery-powered devices. Implementing such algorithms on a resource-constrained device may lead to increased latency, which can affect a user's conversational flow with an automated assistant, or may lead to increased power consumption. This can present a trade-off between achieving effective noise suppression and maintaining a desired level of device performance, potentially affecting the utility of Automatic Speech Recognition (ASR) systems in noisy environments where such devices are often used.

Example implementations of aspects of the present disclosure may provide technical solutions to this problem by implementing a computationally efficient neural network architecture for noise mask prediction. As may be described in one or more claims, the mask prediction neural network may comprise a model with one or more sequential one-dimensional convolutional (Conv1D) layers and one or more Gated Recurrent Unit (GRU) layers. The use of GRU layers can be a technical choice for resource efficiency, as GRUs can be used to process sequential data, such as audio feature streams, with fewer parameters and computational operations as compared to some more complex recurrent units, for instance, Long Short-Term Memory (LSTM) units. This architecture can process features from mid and side audio signals to generate a gain mask while consuming fewer processor cycles and less memory. A resulting technical effect can be a reduction in the computational complexity of the speech enhancement process. This may allow the system to operate in real-time with low latency on a resource-constrained wearable device, thereby addressing some of the processing limitations of other approaches.

Another example technical problem solved by example implementations of aspects of the present disclosure may include the separation of a user's speech from ambient noise in devices with a fixed, close-proximity dual-microphone configuration, such as in earbuds. In such a configuration, while beamforming can enhance a centered sound source, it may provide limited information about the characteristics of off-axis or diffuse background noise. Consequently, a subsequent single-channel enhancement module may not have access to a distinct, contemporaneous noise reference signal. Without a clear representation of both the target speech signal and the noise signal, such modules may have difficulty generating a precise noise-suppressing filter. This can result in the unwanted removal of speech components (speech distortion) or insufficient suppression of noise components, which can degrade the input quality for a downstream technical system, such as an Automatic Speech Recognition (ASR) system.

Example implementations of aspects of the present disclosure may provide technical solutions to this problem by generating and utilizing distinct speech and noise reference signals to inform an enhancement process. As may be described in one or more claims, the system can process audio from two microphones to generate both a mid signal (e.g., a beamformed average) and a side signal (e.g., a difference signal). The mid signal can be generated by combining the audio channels to emphasize the user's centered voice, acting as a speech-plus-noise input. Concurrently, the side signal, which can be created by subtracting one channel from the other, can be used to attenuate the centered user's voice and represent the unaligned environmental noise. The system may then process features extracted from both the mid signal and the side signal with the mask prediction neural network. By providing the network with the side signal as a noise-related input, the model is provided with information on the characteristics of the background noise. A resulting technical effect can be the generation of a gain mask that is informed by the specific noise profile. This may improve the quality of the enhanced audio signal by facilitating noise cancellation while preserving components of the target speech, which in turn can provide an input with improved characteristics for a downstream technical process, such as an ASR model.

Another example technical problem solved by example implementations of aspects of the present disclosure may include the sub-optimal performance of speech enhancement systems that are trained to improve perceptual audio quality for human listeners rather than for a machine-based transcription system. Some enhancement models are trained using loss functions that measure acoustic fidelity, for instance, Mean Squared Error on an audio waveform or a Signal-to-Noise Ratio (SNR). While this may produce an output that sounds clearer to a human ear, it may not result in audio that is optimized for an Automatic Speech Recognition (ASR) model. An ASR model may depend on specific mathematical features within an audio signal, and an enhancement process geared toward human perception can inadvertently distort or remove some of these features. This mismatch in optimization objectives can mean that even if the audio is perceptually improved, the ASR's Word Error Rate (WER) may not improve or could be degraded.

Example implementations of aspects of the present disclosure may provide technical solutions to this problem by integrating an objective of the downstream ASR system into the training process of the enhancement model. As may be described in one or more claims, internal parameters of the mask prediction neural network may be configured using a transcription-driven training process that utilizes a multi-part loss function. This loss function can be derived from an independent, frozen ASR model and may include, for example, an encoder loss and a language model loss from that ASR model. During training, the enhanced audio can be passed to the frozen ASR model, and the resulting internal losses, which can be related to transcription accuracy, may be used to update the enhancement network's parameters. This can create a feedback mechanism that trains the mask prediction network to generate a gain mask that preserves or enhances acoustic features that are salient for machine transcription. A technical effect can be the production of an enhanced audio output that is adapted for the feature space of a machine transcription process. This may lead to an improvement in the performance of a technical system, manifested, for example, as a lower Word Error Rate from the ASR model, by configuring the enhancement process based on the operational needs of the subsequent automated system.

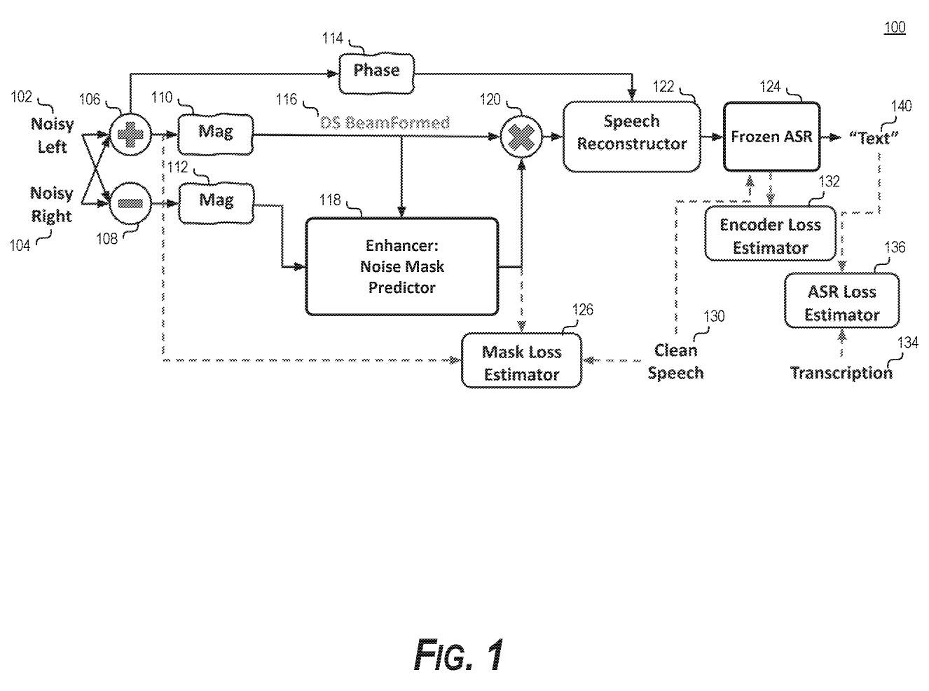

FIG. 1 is a block diagram depicting an example audio enhancement system in accordance with example embodiments of the present disclosure. In some embodiments, the system 100 may be configured to process binaural audio, such as a noisy left audio signal 102 and a noisy right audio signal 104. As depicted, these signals can be processed to generate a delay-and-sum (DS) beamformed signal 116 and a corresponding difference signal. An enhancer 118 (e.g., a noise mask predictor) may be configured to process magnitude information (e.g., 110, 112) from the beamformed and difference signals to generate a noise mask. This mask can be applied, for instance via a combination operation 120, to a magnitude component of the beamformed signal 116. A speech reconstructor 122 may then combine the masked magnitude with a phase component 114 of the beamformed signal to generate an enhanced signal. This enhanced signal can be provided to an automatic speech recognition (ASR) model 124 (e.g., a frozen ASR model), which may be operable to generate a text output 140. FIG. 1 also illustrates an example training configuration where a mask loss estimator 126, an encoder loss estimator 132, and an ASR loss estimator 136 may be used to train the enhancer 118 based on reference inputs such as clean speech 130 and a ground-truth transcription 134.

In some implementations, the audio enhancement system 100 can perform binaural signal processing and beamforming on received audio signals. For example, the system 100 can process a first audio signal, such as a noisy left audio signal 102, and a second audio signal, such as a noisy right audio signal 104, to generate a mid signal and a corresponding side signal. As illustrated, the first audio signal 102 and the second audio signal 104 can be provided to an adder 106. The adder 106 can be configured to execute a summation operation to generate a DS beamformed signal 116, which can operate as the mid signal. This summation can constructively reinforce signal components that are in-phase across both audio channels, such as centered target speech originating from an equidistant source like a user's mouth, which may function to enhance the desired speech content. Concurrently, the system 100 can generate a side signal to serve as a reference for environmental noise characteristics. In some examples, the first audio signal 102 and the second audio signal 104 are also provided to a difference processor 108. The difference processor 108 can generate the side signal, also referred to as a difference signal, based on a difference between the first audio signal and the second audio signal. Such an operation can attenuate common-mode centered speech and isolate differential-mode audio information, which may be characteristic of the ambient or environmental noise field.

Following an initial beamforming process, the system 100 can be configured to perform noise mask prediction and subsequent audio reconstruction. The system can process a DS beamformed signal 116 and a corresponding difference signal to extract one or more relevant features in a time-frequency domain, for instance, by using a Short-Time Fourier Transform (STFT). The feature extraction can generate a first magnitude feature 110 from the beamformed signal and a second magnitude feature 112 from the difference signal. In some implementations, these magnitude features can be, or can be derived from, MFCCs. Both the first magnitude feature 110 and the second magnitude feature 112 can be provided as input to an enhancer 118. In some embodiments, the enhancer 118 can be implemented as a neural network (e.g., a lightweight model, a recurrent neural network, a convolutional neural network, etc.) configured to generate a noise mask. For example, the neural network can comprise a sequence of one-dimensional convolutional (Conv1D) layers and Gated Recurrent Unit (GRU) layers. Based on the input magnitude features, the enhancer 118 can predict a real-valued gain mask, such as an Ideal Ratio Mask (IRM), which can be configured to attenuate noise components. The system can apply the generated gain mask to a magnitude spectrum of the DS beamformed signal 116 via a combination operation 120. In an example implementation, the combination operation 120 can include a multiplication operation. The resulting product, which can be a masked magnitude spectrum, may be provided to a speech reconstructor 122. The speech reconstructor 122 can also be configured to receive a phase component 114 associated with the original DS beamformed signal 116. The speech reconstructor 122 can then combine the masked magnitude spectrum with the phase component 114 to generate an enhanced audio signal, which in some examples can involve performing an inverse STFT to reconstruct a time-domain waveform.

Subsequently, the enhanced mono-channel audio signal produced by the speech reconstructor 122 can be provided as an input to a downstream automatic speech recognition (ASR) model 124. In some implementations, the ASR model 124 can be a pre-trained model, such as a transformer-based model or another suitable speech recognition architecture, that is maintained in a 'frozen' state during the training of the enhancer 118. This operational configuration can serve to confine updates to model weights to the enhancer 118, which can train the enhancer 118 to produce an output that is adapted for a specific, downstream task processor. The ASR model 124 is configured to process the enhanced audio signal to perform speech-to-text conversion. Based on this processing, the ASR model 124 can generate a text transcription 140, which can represent an output of the end-to-end processing pipeline of the system 100.

The audio enhancement system 100 can include a training configuration for updating parameters of the enhancer 118. In some implementations, the training process can be guided by a multi-component loss function configured to optimize the enhancer 118 for a downstream, machine-based listener (e.g., an ASR model, a speaker identification system, etc.), such as the frozen ASR model 124. The multi-component loss function can be derived from a combination of multiple loss components. For example, a first loss component can be calculated by a mask loss estimator 126. The mask loss estimator 126 can be configured to compute a distortion metric (e.g., a mean squared error or L2 loss) between a predicted gain mask generated by the enhancer 118 and a reference mask. The reference mask, in some examples, can be an ideal ratio mask (IRM) or another suitable target mask generated based on a known clean speech reference signal 130 and the corresponding noisy input signals. A second loss component can be computed by an encoder loss estimator 132. The encoder loss estimator 132 can compute a loss based on a distance (e.g., a cosine distance, an L1 distance, or an L2 distance) between a first internal embedding from an ASR encoder and a second internal embedding from the ASR encoder. The first internal embedding can be generated by processing the enhanced mono-channel audio signal from the speech reconstructor 122 through an encoder portion of the frozen ASR model 124. The second internal embedding can be generated by processing the clean speech reference 130 through the same ASR encoder. The distance between these two internal state representations can guide the enhancer 118 to produce audio that results in ASR encoder embeddings more similar to those produced from clean speech. A third loss component can be computed by an ASR loss estimator 136. The ASR loss estimator 136 can calculate a transcription loss based on a comparison between a text output generated by the frozen ASR model 124 from the enhanced audio signal and a ground-truth transcription 134 corresponding to the clean speech reference 130. The inclusion of this ASR-based loss can configure the enhancer 118 to generate an audio output that is more readily transcribable by the ASR model 124. A total loss, which can comprise a weighted sum of the outputs from the mask loss estimator 126, the encoder loss estimator 132, and the ASR loss estimator 136, can then be used to update model weights of the enhancer 118, for instance, via a backpropagation process.

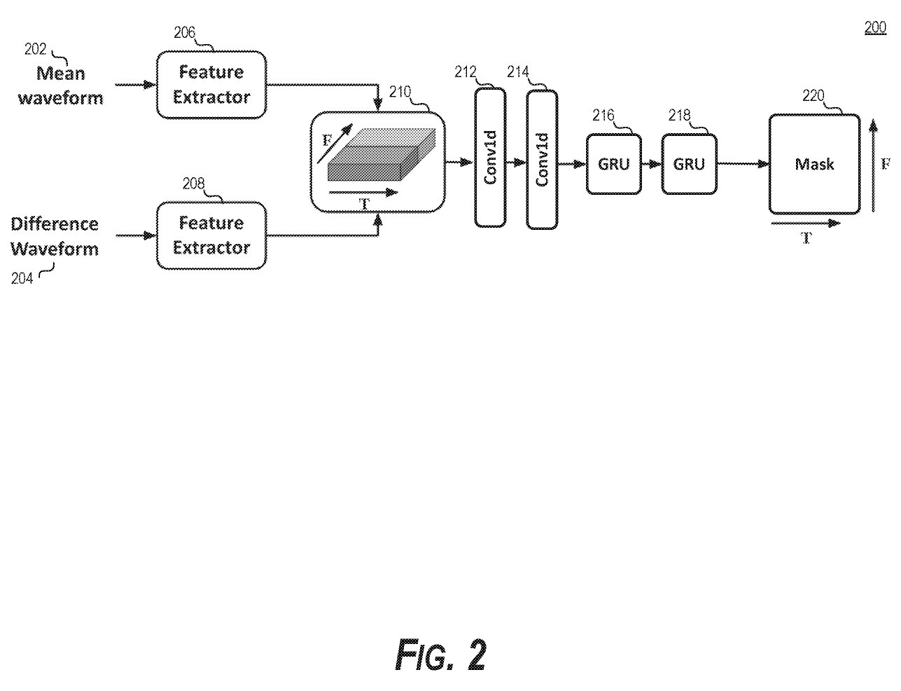

FIG. 2 is a block diagram illustrating an example audio enhancement architecture 200, which may provide a detailed view of the mask prediction neural network described in FIG. 1, in accordance with some embodiments. The architecture 200 may be configured as a lightweight system for real-time noise mask estimation. In the depicted example, the architecture 200 can comprise feature extractors 206 and 208 that are configured to receive a mean waveform 202 and a difference waveform 204, respectively. The extracted features can be subsequently processed by a neural network. For example, the neural network may comprise one or more sequential one-dimensional convolutional (Conv1D) layers (e.g., 212, 214) and one or more Gated Recurrent Unit (GRU) layers (e.g., 216, 218). The sequential layers may be configured to perform temporal feature processing on the extracted features to generate a noise suppression mask 220.

In some implementations, a processing pipeline within the audio enhancement architecture 200 can begin with binaural feature extraction. For example, a feature extractor 206 can be configured to process a mean waveform 202, and a feature extractor 208 can be configured to process a difference waveform 204. These input waveforms can be time-domain signals, where the mean waveform 202 may represent a mixture of a target speech signal and ambient noise, and the difference waveform 204 may represent a spatial profile of an associated ambient noise field. The feature extractors 206 and 208 can operate in parallel to transform the time-domain audio signals into a time-frequency domain representation suitable for processing by a neural network (e.g., a recurrent neural network, a convolutional neural network, a transformer-based model, etc.). This transformation can comprise generating a first set of features from the mean waveform 202 and a second set of features from the difference waveform 204. To generate these features, as one example, the feature extractors 206 and 208 can be configured to compute MFCCs from the respective input waveforms. The computation of MFCCs can provide a compact and perceptually meaningful representation of the spectral content of the audio signals. The first set of features and the second set of features can be subsequently combined, for example by stacking or concatenating, to form a single input feature tensor 210. The feature tensor 210 can be a multi-dimensional structure organized with respect to a frequency axis (F) and a time axis (T), thereby encapsulating both spectral and temporal characteristics of the binaural audio. This combined feature tensor 210 can then be provided as an input sequence to subsequent temporal processing layers of the neural network.

As illustrated, a combined feature tensor 210, which can represent time-frequency domain characteristics of both the mean and difference waveforms, can be provided as an input to a neural network configured for temporal feature processing. In some embodiments, this network can be configured for real-time operation on resource-constrained devices (e.g., smart watches, earbuds, augmented reality glasses, etc.). For example, processing can begin with a sequence of one-dimensional convolutional (Conv1D) layers, such as the Conv1D layers 212 and 214. The Conv1D layers 212 and 214 can be configured to operate along a frequency axis of the feature tensor 210, which can enable the network to identify local patterns and correlations across adjacent frequency bands. The output of the Conv1D layers 212 and 214 can comprise a set of feature maps that encode these localized frequency-domain characteristics. Subsequently, these feature maps can be processed by one or more Gated Recurrent Unit (GRU) layers, such as the GRU layers 216 and 218. The GRU layers, as a form of recurrent neural network, can be configured to model temporal dependencies along a time axis of the input sequence. By processing the sequence of feature vectors over time, the GRU layers 216 and 218 can capture dynamic characteristics and long-range temporal context of both speech and noise components present in the audio signal, which can facilitate an accurate estimation of a subsequent gain mask.

Following the temporal feature processing performed by components such as the GRU layers, the audio enhancement architecture 200 can be configured to generate a noise suppression mask 220. In some implementations, the noise suppression mask 220 can be a time-frequency gain mask configured to suppress noise when applied to a corresponding audio signal. For instance, the noise suppression mask 220 can be configured as a real-valued Ideal Ratio Mask (IRM). To reduce associated computational requirements, the noise suppression mask 220 can be generated using a Mel band structure. The generated noise suppression mask 220 can be an output of the audio enhancement architecture 200 and can be subsequently utilized to modulate a magnitude spectrogram associated with the mid signal, thereby performing noise suppression on the audio.

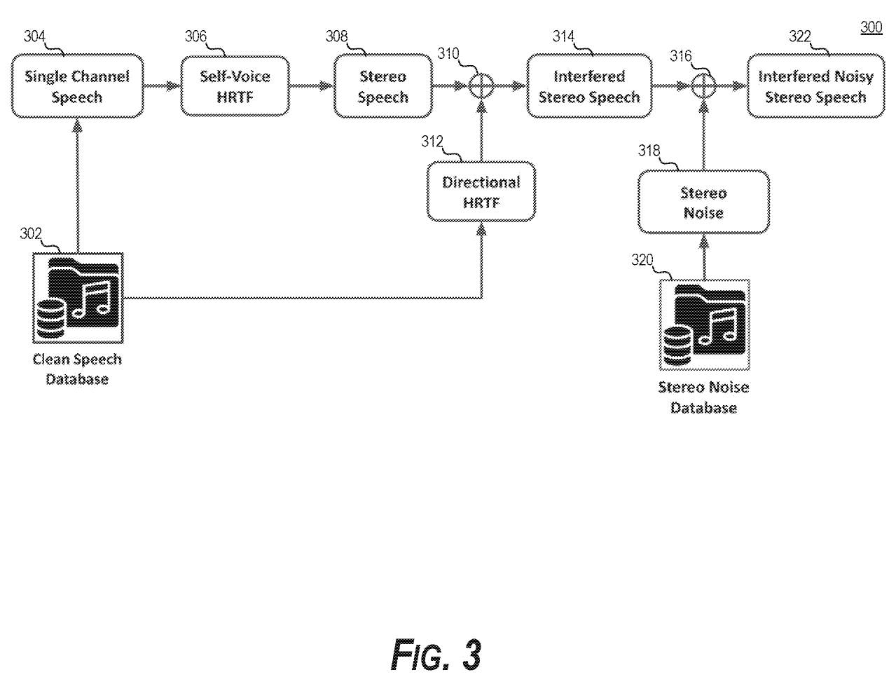

FIG. 3 is a block diagram depicting an example data pipeline 300 that can be used for generating training and evaluation data, for instance, for the audio enhancement system described in FIG. 1, in accordance with some implementations. The data pipeline 300 may be configured to simulate a variety of acoustic scenarios by progressively applying layers of acoustic effects to clean audio signals. In some examples, the process can commence with a single channel of clean speech 304, which may be sourced from a clean speech database 302 (e.g., a publicly available corpus of speech recordings, a proprietary dataset, etc.). A self-voice Head-Related Transfer Function (HRTF) 306 can be applied to the single channel speech 304 to generate stereo speech 308, which can model spatial characteristics of a user's voice. Subsequently, to simulate an interfering talker, a directional HRTF 312, which in some examples may be derived from the clean speech database 302, can be combined with the stereo speech 308 at a first combiner 310 to produce an interfered stereo speech signal 314. To model a more complex acoustic environment, a stereo noise signal 318 sourced from a stereo noise database 320 can be added to the interfered stereo speech 314 at a second combiner 316. This operation may produce a final data sample of interfered noisy stereo speech 322 suitable for use in training or evaluating a machine-learned model.

In some implementations, a data generation process within the data pipeline 300 can begin with sourcing a single-channel speech signal 304 from a clean speech database 302. The clean speech database 302, for example, can comprise a large corpus of audio recordings (e.g., a publicly available dataset, a proprietary collection of recordings, etc.) to provide a set of monophonic audio source material. The single-channel speech signal 304 can be subsequently processed by applying a self-voice Head-Related Transfer Function (HRTF) 306. As one example, this application can be performed via a convolution operation between the single-channel speech signal 304 and an impulse response associated with the self-voice HRTF 306. The self-voice HRTF 306 can be configured to model a specific acoustic transfer function corresponding to a voice of a user as perceived at the ears of the user. To generate such a function, in some examples, acoustic measurements can be captured using a dummy head (e.g., a Head and Torso Simulator or an acoustic mannequin) equipped with one or more audio capture devices (e.g., earbuds, in-ear microphones, etc.). During such a capture process, one or more test signals (e.g., sine-sweeps, impulse sounds, or other calibration signals) can be emitted from a speaker positioned at a mouth location of the dummy head to characterize an acoustic path. The processing of the single-channel speech signal 304 with the self-voice HRTF 306 can result in the generation of a clean stereo speech signal 308. The clean stereo speech signal 308 can be a binaural audio signal that simulates a user hearing a corresponding voice without external interference.

In some implementations, to further enhance the realism of the data generated by the data pipeline 300, a process for simulating an interfering talker can be performed. To this end, a separate speech signal, which in some examples can be sourced from the clean speech database 302, can be processed with a directional Head-Related Transfer Function (HRTF) 312. In some implementations, the directional HRTF 312 can comprise a pre-captured acoustic filter that models the effect of sound arriving from a specific angle relative to a listener (e.g., a user of a wearable device). For example, such a function can be generated by playing sine-sweeps from various angles relative to a measurement apparatus (e.g., a dummy head, a mannequin, etc.) and recording the resulting binaural signal. The convolution of the separate speech signal with the directional HRTF 312 can produce a directional interference signal. Subsequently, at a first combiner 310, this directional interference signal can be additively combined with the previously generated stereo speech 308. The output of this combination operation can be an interfered stereo speech signal 314, which can represent a more complex acoustic scene containing both a spatially-rendered target voice and a spatially distinct interfering voice.

To further simulate a realistic acoustic environment, the data pipeline 300 can be configured to introduce ambient noise. For instance, a pre-recorded stereo noise signal 318 can be sourced from a stereo noise database 320. In some implementations, the stereo noise database 320 can include a collection of real-world binaural noise samples recorded in a plurality of diverse acoustic environments (e.g., cafes, public parks, moving vehicles, etc.) to provide a range of training conditions. For example, the noise samples may be generated by playing back ambisonic recordings through a multi-speaker setup within a controlled space and recording a resulting acoustic field using a dummy head equipped with in-ear microphones or earbuds. This process can capture binaural cues associated with complex, real-world noise fields. Subsequently, the stereo noise signal 318 can be additively combined with the interfered stereo speech 314 at a second combiner 316. This operation can produce a final data sample, identified as interfered noisy stereo speech 322. The resulting signal 322 can represent an acoustic scene comprising a target speaker, a directional interfering speaker, and ambient environmental noise. Such a signal can provide a data sample for training or evaluating an audio enhancement model.

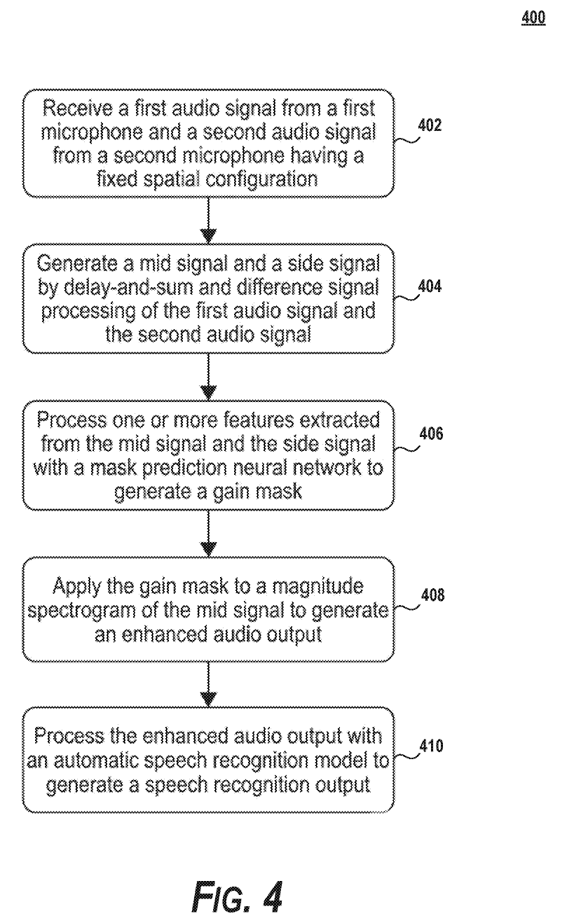

FIG. 4 is a flowchart depicting an example method 400 for processing audio signals from multiple microphones to generate a speech recognition output, in accordance with example aspects of the present disclosure. Method 400 can be performed by the audio enhancement system of FIG. 1 or other appropriately configured computing devices (e.g., a wearable audio device, a smartphone, a smart watch, etc.). The method 400 may commence at block 402, where a first audio signal from a first microphone and a second audio signal from a second microphone having a fixed spatial configuration are received. At block 404, a mid signal and a side signal may be generated based on delay-and-sum and difference signal processing of the first and second audio signals. At block 406, one or more features extracted from the mid and side signals can be processed with a mask prediction neural network to generate a gain mask. At block 408, the generated gain mask may be applied to a magnitude spectrogram of the mid signal to generate an enhanced audio output. The method 400 may conclude at block 410, where the enhanced audio output is processed with an ASR model to generate a speech recognition output.

At block 402, the method 400 can include receiving a first audio signal from a first microphone and a second audio signal from a second microphone, wherein the microphones have a fixed spatial configuration. For example, in an implementation involving a wearable audio device (e.g., a pair of wireless earbuds, a headset, smart glasses), the first microphone can be located on a left component and the second microphone can be located on a right component, which can establish a consistent spatial relationship relative to a mouth of a user. Subsequently, at operation 404, the method 400 can include generating the mid signal and the side signal. In some embodiments, generating the mid signal can comprise averaging the first audio signal and the second audio signal. This averaging operation may be performed without delay compensation to constructively enhance a centered target speech signal. The generation of the side signal can include calculating a difference between the first audio signal and the second audio signal. This difference calculation can attenuate the correlated centered target speech signal while isolating uncorrelated environmental noise, which can result in a side signal that can operate as a noise reference for subsequent processing operations.

At block 406, method 400 can include processing one or more features extracted from the mid signal and the side signal with a mask prediction neural network to generate a gain mask. In some embodiments, the extraction of the one or more features can involve applying a Short-Time Fourier Transform (STFT) to convert the mid and side signals into a time-frequency domain, and subsequently computing acoustic features, such as MFCCs, from the time-frequency representations. These features can serve as inputs for the mask prediction neural network, which, in some examples, can be a lightweight model comprising a sequence of one-dimensional convolutional (Conv1D) layers and Gated Recurrent Unit (GRU) layers. The mask prediction neural network can be configured to estimate the gain mask based on the processed features. For instance, the gain mask can be a real-valued Ideal Ratio Mask (IRM) computed on a Mel band structure to represent a proportion of speech energy relative to noise energy in each frequency band, thereby producing a mask suitable for noise suppression.

At block 408, method 400 can include applying the generated gain mask to a magnitude spectrogram of the mid signal to generate an enhanced audio output. This application may be implemented as an element-wise multiplication of the gain mask with the magnitude spectrogram of the mid signal. This process can selectively attenuate time-frequency bins associated with noise and preserve bins associated with target speech, thereby producing a masked magnitude component. In some implementations, a single enhanced mono-channel audio signal can be reconstructed by combining the masked magnitude component with a preserved phase from the mid signal. An inverse STFT can be applied to facilitate this reconstruction. A suitable analysis window function (e.g., a Vorbis window) may be used during the signal processing to facilitate reconstruction of the time-domain audio signal from the modified spectrogram.

Subsequently, at block 410, method 400 can include processing the enhanced audio output with an automatic speech recognition (ASR) model to generate a speech recognition output. The enhanced audio signal can be provided as input to the ASR model. The ASR model can be configured to process the acoustic features of the enhanced audio signal and convert the speech content into a corresponding text transcription, which can be the speech recognition output.

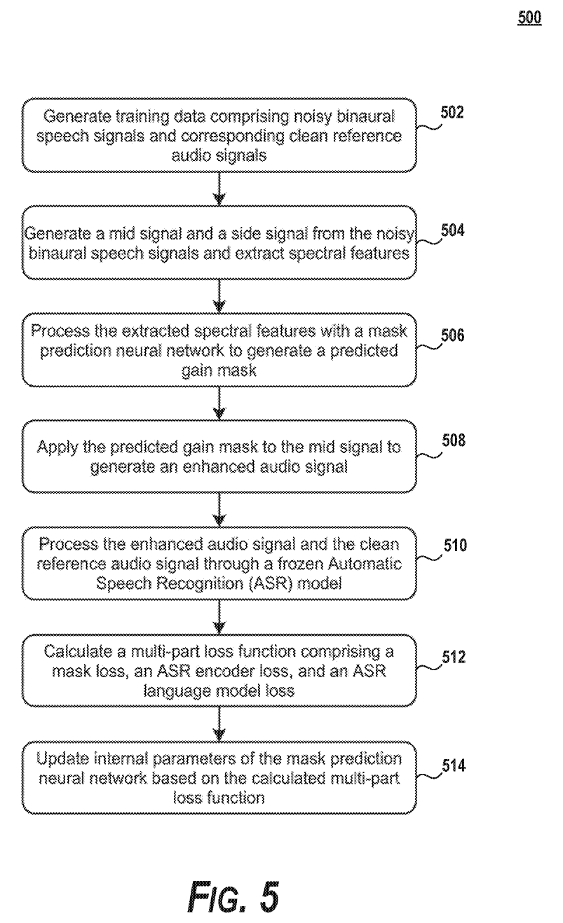

FIG. 5 is a flowchart depicting an example method 500 for training a machine-learned speech enhancement system, in accordance with some implementations of the present disclosure. Method 500 may be used to configure internal parameters of a mask prediction neural network, such as the enhancer described with reference to FIGS. 1 and 2, using a transcription-driven training process. In some examples, method 500 can begin at 502, where training data comprising noisy signals and clean reference signals is generated. At 504, 506, and 508, a noisy audio signal from the training data may be processed to generate an enhanced audio signal. At 510, both the enhanced audio signal and a clean reference audio signal can be processed through a frozen automatic speech recognition (ASR) model. At 512, a multi-part loss function can be calculated, which may comprise a mask loss, an ASR encoder loss, and an ASR language model loss. The method 500 may conclude at 514, where internal parameters of the mask prediction neural network are updated based on the calculated multi-part loss function.

At block 502, method 500 can include generating training data comprising noisy binaural speech signals and corresponding clean reference audio signals. In some implementations, generating training data can leverage a data generation process or pipeline, such as the data pipeline 300 described with reference to FIG. 3, to simulate realistic and diverse acoustic conditions for a wearable audio device. For example, a clean reference audio signal can be sourced from a clean speech database and processed with a self-voice Head-Related Transfer Function (HRTF) to model the spatial characteristics of a user's voice as captured by a pair of microphones. To generate the corresponding noisy binaural speech signals, the system can systematically introduce simulated acoustic interference. This can include applying directional HRTFs to secondary speech signals to model spatially distinct interfering talkers, and additively combining the result with real-world binaural noise recordings (e.g., ambient environments like cafes or parks). By progressively layering these spatial and environmental acoustic effects onto the clean speech, the system can produce a robust dataset of paired clean and noisy audio samples tailored for training the mask prediction neural network to isolate target speech within complex, real-world acoustic fields.

At block 504, method 500 can include generating a mid signal and a side signal from the noisy binaural speech signals and extracting spectral features. In example embodiments, generating the mid signal can involve performing a delay-and-sum beamforming operation, which can comprise averaging a left audio channel and a right audio channel of the noisy binaural speech signal to constructively enhance centered, correlated target speech. Concurrently, the side signal can be generated by calculating a difference between the left and right audio channels, an operation that attenuates the centered target speech while isolating unaligned, differential-mode environmental noise to serve as a spatial noise reference. Following the generation of the time-domain mid and side signals, the system can extract spectral features by transforming the signals into a time-frequency domain representation using, for instance, a Short-Time Fourier Transform (STFT). For example, the extracted spectral features can include MFCCs derived from both the mid signal and the side signal, which may be stacked, concatenated, or otherwise combined into a multi-dimensional feature tensor configured for temporal processing by the subsequent layers of the mask prediction neural network.

At block 506, following the generation and extraction of spectral features, method 500 can include processing the extracted spectral features with a mask prediction neural network to generate a predicted gain mask. As one example, the mask prediction neural network can process Mel-frequency cepstral coefficients derived from both the mid and side signals to produce a real-valued Ideal Ratio Mask that is estimated on a Mel band structure.

Subsequently, at operation 508, method 500 can include applying the predicted gain mask to the mid signal to generate an enhanced audio signal for evaluation. This enhancement operation can, for instance, involve applying the predicted gain mask to a magnitude spectrogram of the mid signal via element-wise multiplication. A resulting masked magnitude component can be combined with a preserved phase component from the mid signal to reconstruct a single enhanced mono-channel audio signal, which can be subsequently provided for loss calculation.

At block 510, method 500 can include processing the enhanced audio signal and the clean reference audio signal through an independent, pre-trained automatic speech recognition (ASR) model. In some implementations, internal parameters of the ASR model can be kept frozen, such that the parameters are not updated during the training of the mask prediction neural network. In some implementations, the pre-trained ASR model can be a model with a transformer-based architecture, which can be maintained in a frozen state such that the associated parameters of the model are not updated during the training of the enhancement system. Both the enhanced audio signal from operation 508 and the ground-truth clean reference audio signal from the training data can be provided as input to the ASR model to generate corresponding internal state representations and text outputs. The frozen ASR model can thereby function as an evaluation tool to measure the performance of the enhancement process with respect to a downstream machine transcription task.

Subsequently, at block 512, method 500 can include calculating a multi-part loss function based on processing the enhanced audio signal and the clean reference audio signal with the ASR model. This calculation can leverage the outputs and internal states from the ASR model to generate a loss value that can be optimized for machine transcription performance. In some examples, the multi-part loss function can comprise three distinct components. A first component can be a mask loss, which can measure a distance (e.g., an L2 distance) between the predicted gain mask generated at operation 506 and an ideal ratio mask derived from the clean reference audio signal. A second component can be an automatic speech recognition encoder loss. According to certain embodiments, the automatic speech recognition encoder loss can comprise a distance between an internal encoder embedding of the enhanced audio signal and an internal encoder embedding of the clean reference audio signal. A third component can be an automatic speech recognition language model loss. In some implementations, the automatic speech recognition language model loss can comprise a transcription-level loss between a text output for the enhanced audio signal and a ground-truth transcription associated with the clean reference audio signal. The combination of these losses can guide the training process to improve not only the signal quality but also the downstream transcription accuracy.

At block 514, method 500 can include updating internal parameters of the mask prediction neural network. For example, the updating can involve combining multiple calculated loss components, such as a mask loss, an ASR encoder loss, and an ASR language model loss, to generate a total loss value. In some implementations, the loss components can be aggregated using a weighted sum. Subsequently, gradients can be computed from the total loss value and can be backpropagated through the network to update adjustable internal parameters of the mask prediction neural network, such as associated weights and biases. In some examples, this optimization process can be configured to adjust the enhancement model while parameters of a pre-trained ASR model can remain frozen or otherwise unmodified. This training process can iteratively configure the enhancement network to generate an output audio signal that may improve performance in a downstream automatic speech recognition task, which can align the signal enhancement with an objective of accurate machine transcription.

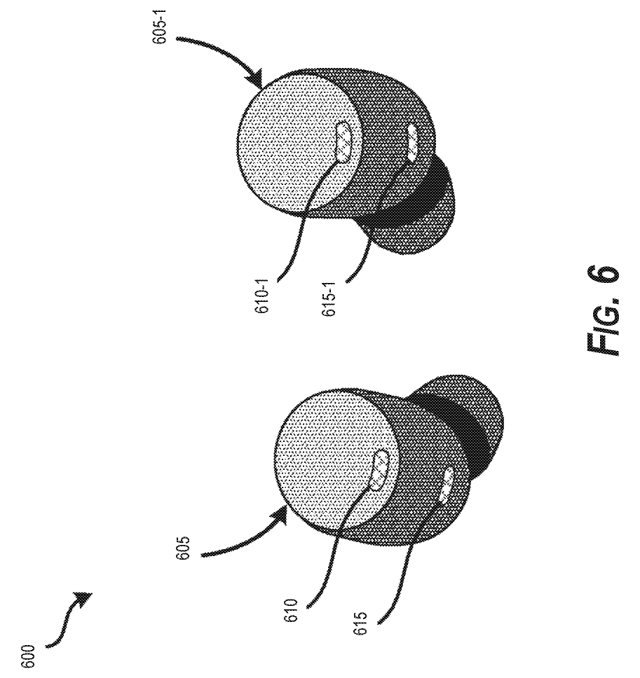

FIG. 6 is a perspective view of a wearables system 600 with a pair of wireless earbuds, representing an example physical form factor for the audio processing system in accordance with example embodiments of the present disclosure. Wearable devices in the wearables system 600 can include the wireless earbuds, such as wireless earbuds 605 and 605-1.

The wireless earbuds 605 and 605-1 can be designed for speech enhancement and noise suppression. Individual ones of the wireless earbuds 605 and 605-1 can include multiple microphones. For example, the earbud 605 can include microphones 610 and 615. In such an example or another example, the earbud 605-1 can include microphones 610-1 and 615-1. Individual ones of the microphones 610 and 615, or a combination thereof, can allow the system 600 to implement audio speech recognition in accordance with example aspects of the present disclosure.

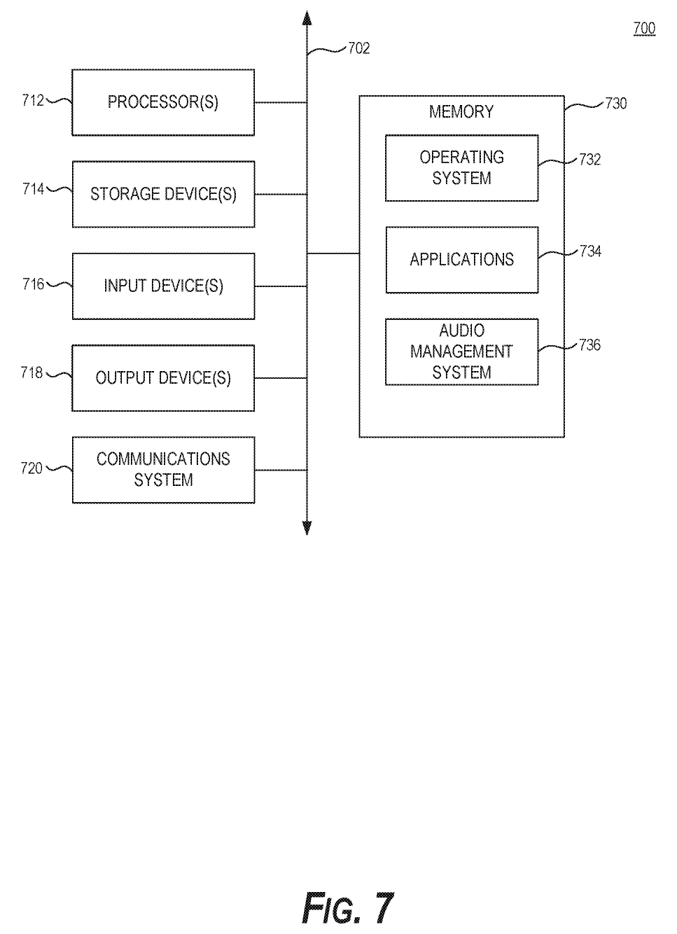

FIG. 7 is a block diagram of an example computational system 700 that can implement various system components and/or perform various steps of methods provided by various embodiments. Embodiments of the computational system 700 can be integrated in a wearable audio component, such as an earbud, headset, etc. Embodiments of the computational system 700 can implement some or all of an audio management system including an audio enhancement system with a speech enhancement model in accordance with example embodiments of the present disclosure. The audio management system can include an automatic noise cancellation system (ANC) and/or and audio processing system (APS) in example embodiments. FIG. 7 is meant only to provide a generalized illustration of various components, any or all of which may be utilized as appropriate. FIG. 7, therefore, broadly illustrates how individual system elements may be implemented in a relatively separated or relatively more integrated manner.

The computational system 700 is shown including hardware elements that can be electrically coupled via a bus 702 (or may otherwise be in communication, as appropriate). The hardware elements may include one or more processors 712, including, without limitation, one or more general-purpose processors and/or one or more special-purpose processors (such as digital signal processing chips, graphics acceleration processors, video decoders, and/or the like); one or more input devices 716; and one or more output devices 718. In the wearable audio component context, the input devices 716 can include wired and/or wireless ports, buttons, switches, microphones, touch interfaces, and/or any other suitable input device 716; and the output devices 718 can include indicator lights, displays, speakers, and/or any other suitable output devices 718.

The computational system 700 may further include (and/or be in communication with) one or more non-transitory storage devices 714, which can comprise, without limitation, local and/or network accessible storage, and/or can include, without limitation, a disk drive, a drive array, an optical storage device, a solid-state storage device, such as a random access memory (“RAM”), and/or a read-only memory (“ROM”), which can be programmable, flash-updateable and/or the like. Such storage devices may be configured to implement any appropriate data stores, including, without limitation, various file systems, database structures, and/or the like. In some embodiments, the storage devices 714 include the audio enhancement system described herein.

The computational system 700 can also include a communications system 720, which can include, without limitation, a modem, a network card (wireless or wired), an infrared communication device, a wireless communication device, and/or a chipset (such as a Bluetooth device, an 802.11 device, a WiFi device, a WiMax device, cellular communication device, etc.), and/or the like. As described herein, the communications system 720 supports multiple communication technologies. Further, as described herein, the communications system 720 can provide communications with one or more networks. For example, embodiments of the communications system 720 can communicate with a remote computing system such as a cloud computing system. Though not explicitly shown, some embodiments interface via the communications system 720, and/or via input devices 716 and output devices 718, with one or more user computational devices.

In many embodiments, the computational system 700 can further include a working memory 730, which can include a RAM or ROM device, as described herein. The computational system 700 also can include software elements, shown as currently being located within the working memory 730, including an operating system 732, device drivers, executable libraries, and/or other code, such as one or more application programs 734, and audio management system 736, which may include computer programs provided by various embodiments, and/or may be designed to implement methods, and/or configure systems, provided by other embodiments, as described herein. Merely by way of example, one or more procedures described with respect to the method(s) discussed herein can be implemented as code and/or instructions executable by a computer (and/or a processor within a computer); in an aspect, then, such code and/or instructions can be used to configure and/or adapt a general-purpose computer (or other device) to perform one or more operations in accordance with the described methods. In some embodiments, the operating system 732 and the working memory 730 are used in conjunction with the one or more processors 712 to implement some or all of the audio management system components, such as the audio enhancement system.

A set of these instructions and/or codes can be stored on a non-transitory computer-readable storage medium, such as the non-transitory storage device(s) 714 described above. In some cases, the storage medium can be incorporated within a computer system, such as computer system 700. In other embodiments, the storage medium can be separate from a computer system (e.g., a removable medium, such as a compact disc), and/or provided in an installation package, such that the storage medium can be used to program, configure, and/or adapt a general-purpose computer with the instructions/code stored thereon. These instructions can take the form of executable code, which is executable by the computational system 700 and/or can take the form of source and/or installable code, which, upon compilation and/or installation on the computational system 700 (e.g., using any of a variety of generally available compilers, installation programs, compression/decompression utilities, etc.), then takes the form of executable code.

It will be apparent to those skilled in the art that substantial variations may be made in accordance with specific requirements. For example, customized hardware can also be used, and/or particular elements can be implemented in hardware, software (including portable software, such as applets, etc.), or both. Further, connection to other computing devices, such as network input/output devices, may be employed.

As mentioned above, in one aspect, some embodiments may employ a computer system (such as the computer system 700) to perform methods in accordance with various embodiments of the invention. According to a set of embodiments, some or all of the procedures of such methods are performed by the computational system 700 in response to processor 712 executing one or more sequences of one or more instructions (which can be incorporated into the operating system 732 and/or other code, such as an application program 734) contained in the working memory 730. Such instructions may be read into the working memory 730 from another computer-readable medium, such as one or more of the non-transitory storage device(s) 714. Merely by way of example, execution of the sequences of instructions contained in the working memory 730 can cause the processor(s) 712 to perform one or more procedures of the methods described herein.

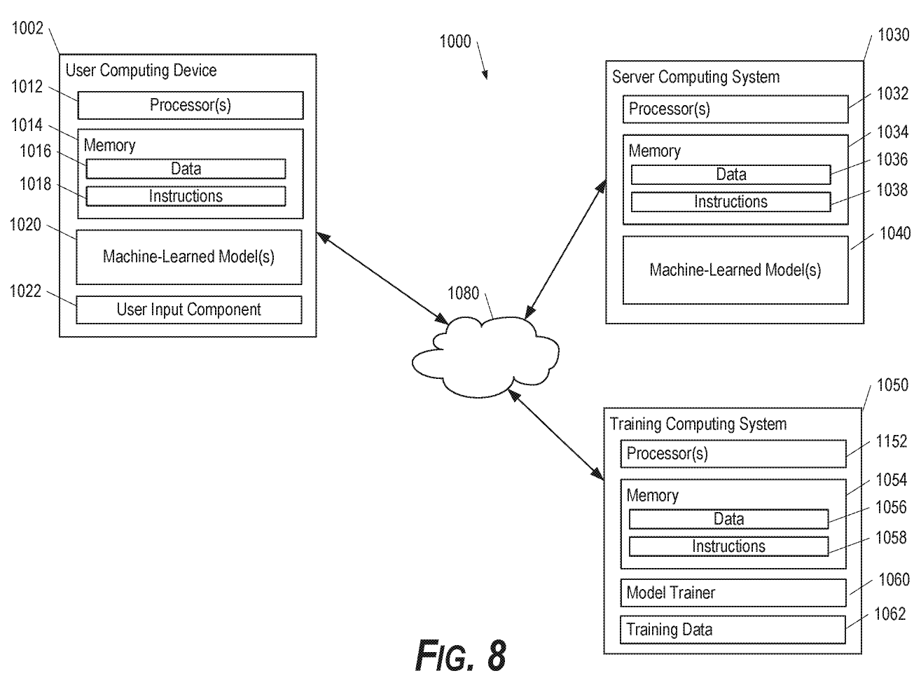

FIG. 8 depicts a block diagram of an example computing system 1000 that according to example embodiments of the present disclosure. The system 1000 includes a user computing device 1002, a server computing system 1030, and a training computing system 1050 that are communicatively coupled over a network 1080.

The user computing device 1002 can be any type of computing device, such as, for example, a personal computing device (e.g., laptop or desktop), a mobile computing device (e.g., smartphone or tablet), a gaming console or controller, a wearable computing device, an embedded computing device, or any other type of computing device.

The user computing device 1002 includes one or more processors 1012 and a memory 1014. The one or more processors 1012 can be any suitable processing device (e.g., a processor core, a microprocessor, an ASIC, a FPGA, a controller, a microcontroller, etc.) and can be one processor or a plurality of processors that are operatively connected. The memory 1014 can include one or more non-transitory computer-readable storage mediums, such as RAM, ROM, EEPROM, EPROM, flash memory devices, magnetic disks, etc., and combinations thereof. The memory 1014 can store data 1016 and instructions 1018 which are executed by the processor 1012 to cause the user computing device 1002 to perform operations.

In some implementations, the user computing device 1002 can store or include one or more machine-learned models 1020. For example, the machine-learned models 1020 can be or can otherwise include various machine-learned models such as neural networks (e.g., deep neural networks) or other types of machine-learned models, including non-linear models and/or linear models. Neural networks can include feed-forward neural networks, recurrent neural networks (e.g., long short-term memory recurrent neural networks), convolutional neural networks or other forms of neural networks. Some example machine-learned models can leverage an attention mechanism such as self-attention. For example, some example machine-learned models can include multi-headed self-attention models (e.g., transformer models). Example machine-learned models 1020 can include a speech enhancement model, an enhancement mask predictor, a speech reconstructor, and/or an ASR model as described herein.

In some implementations, the one or more machine-learned model(s) 1020 can be received from the server computing system 1030 over network 1080, stored in the user computing device memory 1014, and then used or otherwise implemented by the one or more processors 1012. In some implementations, the user computing device 1002 can implement multiple parallel instances of the machine-learned models 1020 (e.g., to perform parallel inference generation across multiple instances of sensor data).

Additionally or alternatively to machine-learned model(s) 1020, one or more machine-learned model(s) 1040 can be included in or otherwise stored and implemented by the server computing system 130 that communicates with the user computing device 1002 according to a client-server relationship. For example, the machine-learned model(s) 1040 can be implemented by the server computing system 1030 as a portion of a web service (e.g., an image processing service). Thus, one or more machine-learned model(s) can be stored and implemented at the user computing device 1002 and/or one or more machine-learned model(s) can be stored and implemented at the server computing system 1030. The one or more machine-learned model(s) 1040 can be the same as or similar to the one or more machine-learned model(s) 1020.

The user computing device 1002 can also include one or more user input components 1022 that receive user input. For example, the user input component 1022 can be a touch-sensitive component that is sensitive to the touch of a user input object (e.g., a finger or a stylus). The touch-sensitive component can serve to implement a virtual keyboard. Other example user input components include a microphone, a traditional keyboard, or other means by which a user can provide user input.

The server computing system 1030 includes one or more processors 1032 and a memory 1034. The one or more processors 1032 can be any suitable processing device (e.g., a processor core, a microprocessor, an ASIC, a FPGA, a controller, a microcontroller, etc.) and can be one processor or a plurality of processors that are operatively connected. The memory 1034 can include one or more non-transitory computer-readable storage mediums, such as RAM, ROM, EEPROM, EPROM, flash memory devices, magnetic disks, etc., and combinations thereof. The memory 1034 can store data 1036 and instructions 1038 which are executed by the processor 1032 to cause the server computing system 1030 to perform operations.

In some implementations, the server computing system 1030 includes or is otherwise implemented by one or more server computing devices. In instances in which the server computing system 1030 includes plural server computing devices, such server computing devices can operate according to sequential computing architectures, parallel computing architectures, or some combination thereof.

As described above, the server computing system 1030 can store or otherwise include one or more machine-learned model(s) 1040. For example, the machine-learned model(s) can be or can otherwise include various machine-learned models. Example machine-learned models include neural networks or other multi-layer non-linear models. Example neural networks include feed forward neural networks, deep neural networks, recurrent neural networks, and convolutional neural networks. One example model is discussed with reference to FIG. 1.

The user computing device 1002 and/or the server computing system 1030 can train the machine-learned model(s) 1020 and 1040 via interaction with the training computing system 1050 that is communicatively coupled over the network 1080. The training computing system 1050 can be separate from the server computing system 1030 or can be a portion of the server computing system 1030.

The training computing system 1050 includes one or more processors 1152 and a memory 1054. The one or more processors 1052 can be any suitable processing device (e.g., a processor core, a microprocessor, an ASIC, a FPGA, a controller, a microcontroller, etc.) and can be one processor or a plurality of processors that are operatively connected. The memory 1054 can include one or more non-transitory computer-readable storage mediums, such as RAM, ROM, EEPROM, EPROM, flash memory devices, magnetic disks, etc., and combinations thereof. The memory 1054 can store data 1056 and instructions 1058 which are executed by the processor 1152 to cause the training computing system 1050 to perform operations. In some implementations, the training computing system 1050 includes or is otherwise implemented by one or more server computing devices.

The training computing system 1050 can include a model trainer 1060 that trains a machine-learned model(s) 1020 and 1040 stored at the user computing device 1002 and/or the server computing system 1030 using various training or learning techniques, such as, for example, backwards propagation of errors. In other examples as described herein, training computing system 1050 can train a machine-learned model(s) prior to deployment for provisioning of the machine-learned model at user computing device 1002 or server computing system 1030. The machine-learned models 1020 and 1040 can be stored at training computing system 1050 for training and then deployed to user computing device 1002 and server computing system 1030. In some implementations, performing backwards propagation of errors can include performing truncated backpropagation through time. The model trainer 1060 can perform a number of generalization techniques (e.g., weight decays, dropouts, etc.) to improve the generalization capability of the models being trained.

In particular, the model trainer 1060 can train the machine-learned model(s) 1020 and 1040 based on a set of training data 1062. The training data 1062 can include, for example, a plurality of instances of sensor data, where each instance of sensor data has been labeled with ground truth inferences such as gesture detections and/or movement recognitions. For example, the label(s) for each training image can describe the position and/or movement (e.g., velocity or acceleration) of a touch input or an object movement. In some implementations, the labels can be manually applied to the training data by humans. In some implementations, the models can be trained using a loss function that measures a difference between a predicted inference and a ground-truth inference.

In some implementations, if the user has provided consent, the training examples can be provided by the user computing device 1002. Thus, in such implementations, the machine-learned model 1020 provided to the user computing device 1002 can be trained by the training computing system 1050 on user-specific data received from the user computing device 1002. In some instances, this process can be referred to as personalizing the model.

The model trainer 1060 includes computer logic utilized to provide desired functionality. The model trainer 1060 can be implemented in hardware, firmware, and/or software controlling a general purpose processor. For example, in some implementations, the model trainer 1060 includes program files stored on a storage device, loaded into a memory and executed by one or more processors. In other implementations, the model trainer 1060 includes one or more sets of computer-executable instructions that are stored in a tangible computer-readable storage medium such as RAM hard disk or optical or magnetic media.

The network 1080 can be any type of communications network, such as a local area network (e.g., intranet), wide area network (e.g., Internet), or some combination thereof and can include any number of wired or wireless links. In general, communication over the network 1080 can be carried via any type of wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL).

FIG. 8 illustrates one example computing system that can be used to implement the present disclosure. Other computing systems can be used as well. For example, in some implementations, the user computing device 1002 can include the model trainer 1060 and the training data 1062. In such implementations, the machine-learned model 1020 can be both trained and used locally at the user computing device 1002. In some of such implementations, the user computing device 1002 can implement the model trainer 1060 to personalize the machine-learned model(s) 1020 based on user-specific data.

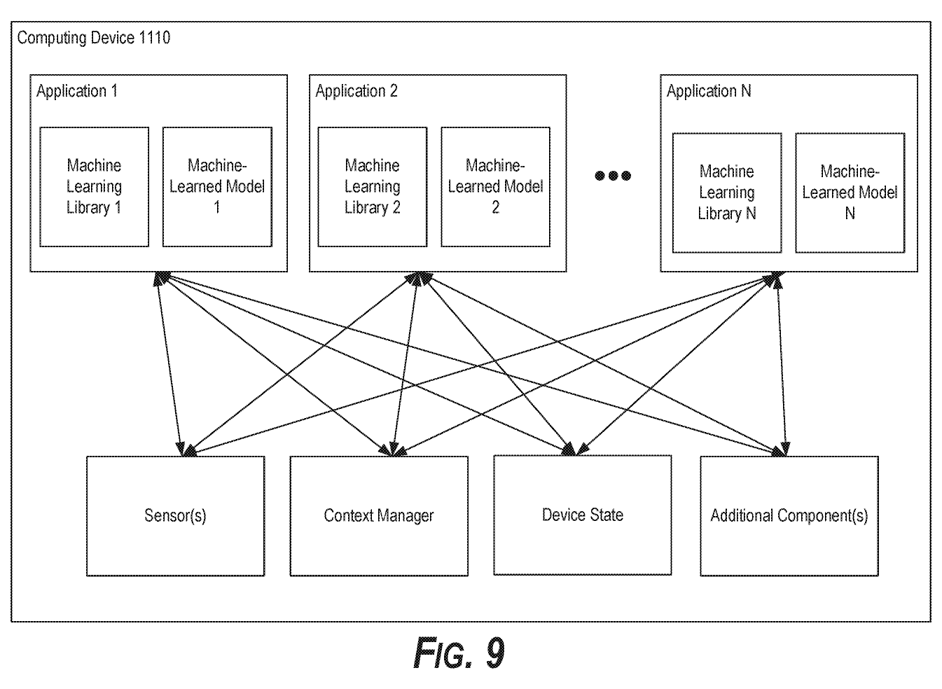

FIG. 9 depicts a block diagram of an example computing device 1110 that performs according to example embodiments of the present disclosure. The computing device 1110 can be a user computing device or a server computing device.

The computing device 1110 includes a number of applications (e.g., applications 1 through N). Each application contains its own machine learning library and machine-learned model(s). For example, each application can include a machine-learned model. Example applications include a text messaging application, an email application, a dictation application, a virtual keyboard application, a browser application, etc.

As illustrated in FIG. 7, each application can communicate with a number of other components of the computing device, such as, for example, one or more sensors, a context manager, a device state component, and/or additional components. In some implementations, each application can communicate with each device component using an API (e.g., a public API). In some implementations, the API used by each application is specific to that application.

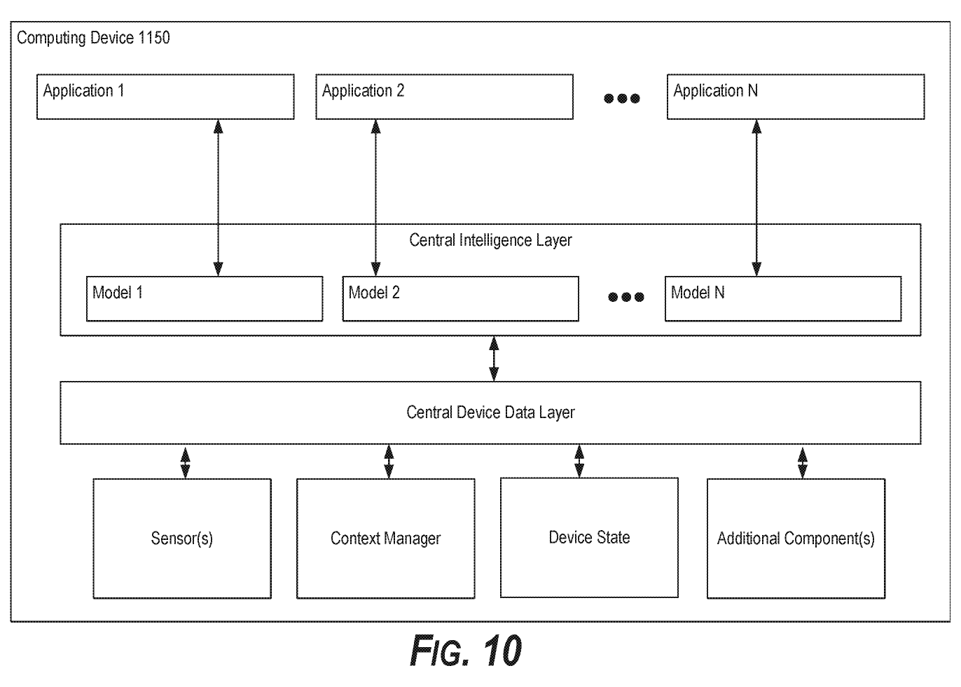

FIG. 10 depicts a block diagram of an example computing device 1150 that performs according to example embodiments of the present disclosure. The computing device 1150 can be a user computing device or a server computing device.

The computing device 1150 includes a number of applications (e.g., applications 1 through N). Each application is in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer includes a number of machine-learned models. For example, as illustrated in FIG. 10, a respective machine-learned model (e.g., a model) can be provided for each application and managed by the central intelligence layer. In other implementations, two or more applications can share a single machine-learned model. For example, in some implementations, the central intelligence layer can provide a single model (e.g., a single model) for all of the applications. In some implementations, the central intelligence layer is included within or otherwise implemented by an operating system of the computing device 1150.

The central intelligence layer can communicate with a central device data layer. The central device data layer can be a centralized repository of data for the computing device 1150. As illustrated in FIG. 12, the central device data layer can communicate with a number of other components of the computing device, such as, for example, one or more sensors, a context manager, a device state component, and/or additional components. In some implementations, the central device data layer can communicate with each device component using an API (e.g., a private API).

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

Aspects of the disclosure have been described in terms of illustrative embodiments thereof. Any and all features in the following claims can be combined or rearranged in any way possible, including combinations of claims not explicitly enumerated in combination together, as the example claim dependencies listed herein should not be read as limiting the scope of possible combinations of features disclosed herein. Accordingly, the scope of the present disclosure is by way of example rather than by way of limitation, and the subject disclosure does not preclude inclusion of such modifications, variations or additions to the present subject matter as would be readily apparent to one of ordinary skill in the art. Moreover, terms are described herein using lists of example elements joined by conjunctions such as “and,” “or,” “but,” etc. It should be understood that such conjunctions are provided for explanatory purposes only. Clauses and other sequences of items joined by a particular conjunction such as “or,” for example, can refer to “and/or,” “at least one of”, “any combination of” example elements listed therein, etc. Terms such as “based on” should be understood as “based at least in part on.”

The term “can” should be understood as referring to a possibility of a feature in various implementations and not as prescribing an ability that is necessarily present in every implementation. For example, the phrase “X can perform Y” should be understood as indicating that, in various implementations, X has the potential to be configured to perform Y, and not as indicating that in every instance X must always be able to perform Y. It should be understood that, in various implementations, X might be unable to perform Y and remain within the scope of the present disclosure.

The term “may” should be understood as referring to a possibility of a feature in various implementations and not as prescribing an ability that is necessarily present in every implementation. For example, the phrase “X may perform Y” should be understood as indicating that, in various implementations, X has the potential to be configured to perform Y, and not as indicating that in every instance X must always be able to perform Y. It should be understood that, in various implementations, X might be unable to perform Y and remain within the scope of the present disclosure.

What is claimed is:

1. An audio enhancement system, comprising:
a first microphone and a second microphone having a fixed spatial configuration;
one or more processors; and
a memory including instructions that when executed by the one or more processors cause the audio enhancement system to perform operations, the operations comprising:
generating a mid signal and a side signal by delay-and-sum and difference signal processing of a first audio signal from the first microphone and a second audio signal from the second microphone;
processing one or more features extracted from the mid signal and side signal with a mask prediction neural network to generate a gain mask;
applying the gain mask to a magnitude spectrogram of the mid signal to generate an enhanced audio output; and
processing the enhanced audio output with an automatic speech recognition model to generate a speech recognition output.

2. The audio enhancement system of claim 1, wherein the mask prediction neural network comprises a lightweight binaural enhancement model comprising one or more sequential one-dimensional convolutional (Conv1D) layers and one or more Gated Recurrent Unit (GRU) layers configured for temporal feature processing.

3. The audio enhancement system of claim 1, wherein applying the gain mask to the magnitude spectrogram of the mid signal yields a masked magnitude component, and wherein the operations further comprise generating a single enhanced mono-channel audio signal prior to processing by the automatic speech recognition model by combining the masked magnitude component with a preserved phase component of the mid signal.

4. The audio enhancement system of claim 3, wherein the operations further comprise applying a Vorbis window during extraction of the one or more features and reconstruction of the single enhanced mono-channel audio signal.

5. The audio enhancement system of claim 1, wherein the mask prediction neural network utilizes a Mel band structure to estimate the gain mask, and wherein the gain mask comprises a real-valued Ideal Ratio Mask (IRM) representing a ratio of target speech energy to total mixture energy.

6. The audio enhancement system of claim 1, wherein internal parameters of the mask prediction neural network are configured via a transcription-driven training process utilizing a multi-part loss function that includes at least an encoder loss and a language model loss.

7. The audio enhancement system of claim 6, wherein the encoder loss and the language model loss are derived from an independent, frozen automatic speech recognition model such that the generated gain mask is optimized for a machine transcription feature space.

8. The audio enhancement system of claim 7, wherein the multi-part loss function further comprises a mask loss calculated as an L2 loss between the generated gain mask and an ideal ratio mask associated with a clean reference audio signal.

9. The audio enhancement system of claim 1, wherein the one or more features extracted from the mid signal and the side signal comprise Mel-frequency cepstral coefficients (MFCCs).

10. The audio enhancement system of claim 1, wherein generating the mid signal comprises generating a beamformed average signal by averaging the first audio signal and the second audio signal.

11. The audio enhancement system of claim 1, wherein generating the side signal comprises subtracting the second audio signal from the first audio signal to attenuate a centered target speech signal and isolate unaligned environmental noise.

12. The audio enhancement system of claim 1, wherein the one or more features include a first set of spectral features and a second set of spectral features, the operations further comprising:
extracting the first set of spectral features from the mid signal and the second set of spectral features from the side signal.

13. The audio enhancement system of claim 1, wherein the enhanced audio output is an enhanced magnitude spectrogram.

14. A method for audio enhancement, comprising:
receiving, by one or more computing devices, a first audio signal from a first microphone and a second audio signal from a second microphone, wherein the first microphone and the second microphone have a fixed spatial configuration;
generating a mid signal and a side signal by delay-and-sum and difference signal processing of the first audio signal and the second audio signal;
processing one or more features extracted from the mid signal and the side signal with a mask prediction neural network to generate a gain mask;
applying the gain mask to a magnitude spectrogram of the mid signal to generate an enhanced audio output; and
processing the enhanced audio output with an automatic speech recognition model to generate a speech recognition output.

15. The method of claim 14, wherein the mask prediction neural network comprises a lightweight binaural enhancement model comprising one or more sequential one-dimensional convolutional (Conv1D) layers and one or more Gated Recurrent Unit (GRU) layers configured for temporal feature processing.

16. The method of claim 14, wherein applying the gain mask to the magnitude spectrogram of the mid signal yields a masked magnitude component, the method further comprising:
generating a single enhanced mono-channel audio signal prior to processing by the automatic speech recognition model by combining the masked magnitude component with a preserved phase component of the mid signal.

17. The method of claim 14, wherein internal parameters of the mask prediction neural network are configured via a transcription-driven training process utilizing a multi-part loss function that includes at least an encoder loss and a language model loss.

18. The method of claim 17, wherein the encoder loss and the language model loss are derived from an independent, frozen automatic speech recognition model such that the generated gain mask is optimized for a machine transcription feature space.

19. A computer-implemented method, comprising:
accessing training data comprising a noisy binaural speech signal and a corresponding clean reference audio signal;
generating a mid signal and a side signal from the noisy binaural speech signal; extracting one or more spectral features from the mid signal and the side signal;
processing the extracted one or more spectral features with a mask prediction neural network to generate a predicted gain mask;
applying the predicted gain mask to the mid signal to generate an enhanced audio signal;
processing the enhanced audio signal and the clean reference audio signal through an independent automatic speech recognition (ASR) model, wherein internal parameters of the independent ASR model are maintained in a frozen state such that the internal parameters of the independent ASR model are not updated during training of the mask prediction neural network;
calculating a multi-part loss function based on processing the enhanced audio signal and the clean reference audio signal through the independent ASR model; and
updating one or more internal parameters of the mask prediction neural network based on the calculated multi-part loss function.

20. The computer-implemented method of claim 19, wherein the multi-part loss function comprises:
an ASR encoder loss based on a distance between a first internal embedding generated by an encoder of the independent ASR model for the enhanced audio signal and a second internal embedding generated by the encoder of the independent ASR model for the clean reference audio signal;
an ASR language model loss based on a comparison between a text output generated by the independent ASR model for the enhanced audio signal and a ground-truth transcription associated with the clean reference audio signal; and
a mask loss based on a difference between the predicted gain mask and an ideal ratio mask derived from the clean reference audio signal.
